(19) United States
(12) Patent Application Publication
(10) Pub. No.: US 2012/0254294 A1
(43) Pub. Date: Oct. 4, 2012

(54) Mainframe Web Client Servlet

(75) Inventors: Jose H. Cifuentes, JR., Miami, FL (US); Anuja Deedwaniya, Poughkeepsie, NY (US); Nina J. Goradia, Rochester, MN (US); Michael P. Kasper, Poughkeepsie, NY (US); Steven G. Kavka, Rochester, MN (US); Gary S. Puchkoff, Poughkeepsie, NY (US)

(73) Assignee: INTERNATIONAL BUSINESS MACHINES CORPORATION, Armonk, NY (US)

(21) Appl. No.: 13/079,395

(22) Filed: Apr. 4, 2011

(51) Int. Cl. G06F 15/16

(52) U.S. Cl. 709/203

(57) ABSTRACT

A method includes receiving a request for a time sharing option (TSO) address space from a client application, reserving a TSO address space in a processor, initializing a interactive system productivity facility (ISPF) session in the TSO address space, initializing a message queue associated with the TSO address space and the ISPF session, generating a unique key associated with the client application, the TSO address space, the ISPF session, and the message queue, and entering the unique key and the association of the unique key with the client application, the TSO address space, the ISPF session, and the message queue into a hash map entry.

The present invention relates to mainframe computing, and more specifically, to mainframe computing with a webclient servlet.

Mainframe computers typically interact with terminals that are communicatively connected to the mainframe. The terminals are operative to send and receive messages and data using time sharing option (TSO) messages and interactive system productivity facility (ISPF) messages. TSO allows a user to, for example, create, maintain, and compile programs and interactively test batch and on-line programs. ISPF provides a terminal interface having a set of panels. The panels often include means to run tools on TSO. ISPF often includes an application programming interface (API).

### BRIEF SUMMARY

According to one embodiment of the present invention, a method includes receiving a request for time sharing option (TSO) address space from a client application, reserving a TSO address space in a processor, initializing a interactive system productivity facility (ISPF) in the TSO address space, initializing a message queue associated with the TSO address space and the ISPF, generating a unique key associated with the client application, the TSO address space, the ISPF, and the message queue, and entering the unique key and the association of the unique key with the client application, the TSO address space, the ISPF, and the message queue into a hash map entry.

According to another embodiment of the present invention, a method includes receiving a request to interrupt a process from a client application, retrieving a unique key from the request, identifying a TSO address space of a processor associated with the unique key, determining whether the request includes a request to interrupt a process in the TSO address space, and calling the TSO address space with an interrupt instruction responsive to determining that the request includes a request to interrupt the process in the TSO address space.

According to yet another embodiment of the present invention, a system includes a processor operative to receive a request for time sharing option (TSO) address space from a client application, reserve a TSO address space, initialize a interactive system productivity facility (ISPF) in the TSO address space, initialize a message queue associated with the TSO address space and the ISPF, generate a unique key associated with the client application, the TSO address space, the ISPF, and the message queue, and enter the unique key and the association of the unique key with the client application, the TSO address space, the ISPF, and the message queue into a hash map entry.

According to yet another embodiment of the present invention, a system includes a processor operative to receive a request to interrupt a process from a client application, retrieve a unique key from the request, identify a TSO address space associated with the unique key, determine whether the request includes a request to interrupt a process in the TSO address space, and call the TSO address space with an interrupt instruction responsive to determining that the request includes a request to interrupt the process in the TSO address space.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a block diagram of an exemplary embodiment of a system.

FIGS. 2A-2C illustrate a block diagram of an exemplary method for initializing TSO address space of FIG. 1.

FIGS. 3A-3B illustrate a block diagram of an exemplary method for retrieving data from the TSO and ISPF of FIG. 1.

FIG. 4 illustrates a block diagram of an exemplary method for sending data to the TSO and ISPF of FIG. 1.

FIGS. 5A-5C illustrate a block diagram of an exemplary method for interrupting processes.

### DETAILED DESCRIPTION

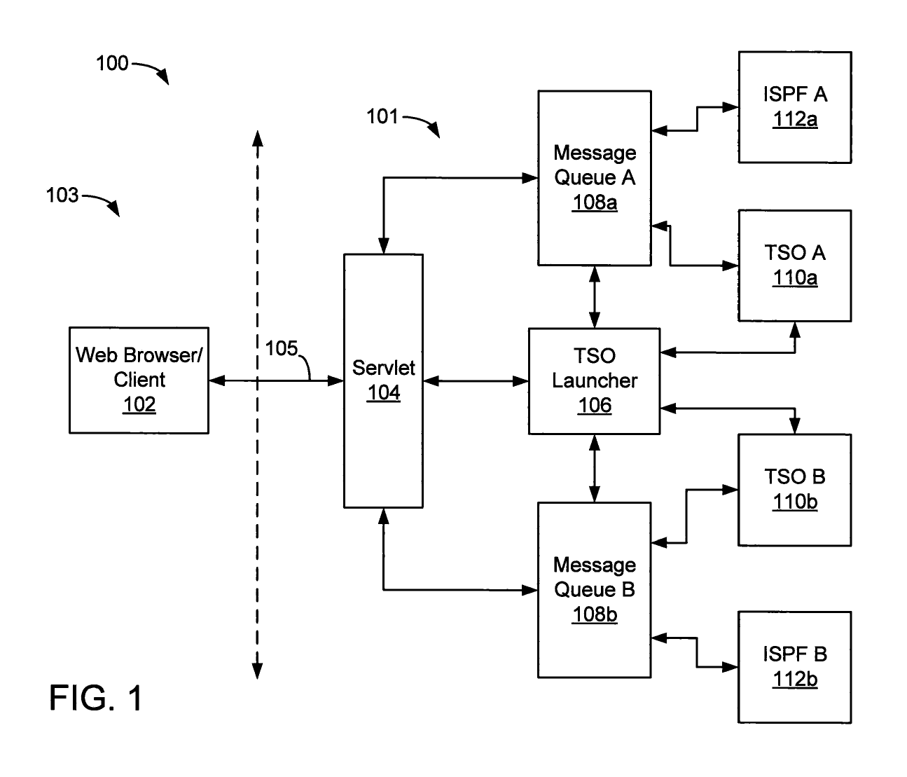

FIG. 1 illustrates a block diagram of an exemplary embodiment of a system 100. The system 100 includes a processor 101 that includes, for example a processor such as a mainframe and associated memory, input, and output devices that are operative to perform, for example, processing tasks and applications, and a user processor 103 that may include, for example a processing terminal or computer that includes a processor, memory, input, output, and display devices that are operative to perform processing tasks and applications. The user processor 103 includes a web browser and/or web client (client) 102 that operates on a computer and is communicatively connected to the processor 101 via a communicative link 105 that may include, for example, an Internet or other type of network communicative connection. The client 102 is operative to send and receive data to and from the processor 101 and present the data to a user. In the illustrated embodiment, the client 102 acts as a terminal user interface. The processor 101 includes a number of entities that may include for example, applications or services that may be processed and performed by the processor 101. The processor 101 includes a servlet portion 104 that is communicatively connected to the client 102. The servlet 104 is operative to send and receive data from a time sharing option (TSO) launcher portion 106 and message queues A and B 108a and 108b. Each message queue 108 is associated with a time sharing option (TSO) address space and an interactive system productivity facility (ISPF) session. Where the message queue A 108a is associated and communicative with the TSO A 110a, the ISPF A 112a, and the TSO launcher 106, and the message queue B 108b is associated and communicative with the TSO B 110b, the ISPF B 112b, and the TSO launcher 106. The operation of the servlet 104 and the TSO launcher 106 will be described in further detail below. Though the illustrated embodiment includes a single client 102, alternate embodiments may include any number of similar clients 102 that may be communicatively connected to the servlet 104. The processor 101 may perform or reserve address spaces for any number of message queues 108 and associated TSOs 110 and ISPFs 112.

In this regard, the servlet 104 provides interfaces for the client 102 to request a TSO 110 address space. Once the TSO address space 110 is reserved, the servlet 104 facilitates communications between the client 102 and the TSO 110 address space and ISPF 112. In this regard, the servlet 104 manages the receipt of messages from the client 102 in HTTP format and forwards the messages to the TSO 110 and ISPF 112 in JSON format via the message queue. Conversely, the servlet 104 receives messages from the TSO 110 and ISPF 112 in JSON format via the message queue 108 and forwards the messages to the client 102 in HTTP format. The servlet 104 provides a service to the client 102 to, for example, terminate the address space and provides “housekeeping duties” to properly maintain the address spaces in the processor 101. In the illustrated embodiments the interactions with the message queues 108, TSO launcher 106 and TSO 110 address spaces may be performed using user credentials provided by the client 102. The servlet 104 maintains a hash map that maps the client 102 or user to the proper message queue 108 and maintains other pertinent data. The servlet 104 maintains a hash map entry for all of the active TSO address spaces that the servlet 104 has started. The hash map includes relevant information about the TSO 110 address space and the associated web browser session, including a unique servlet key (tsoid), timestamps, state information, and data returned by the TSO launcher 106 such as the message queue identifier.

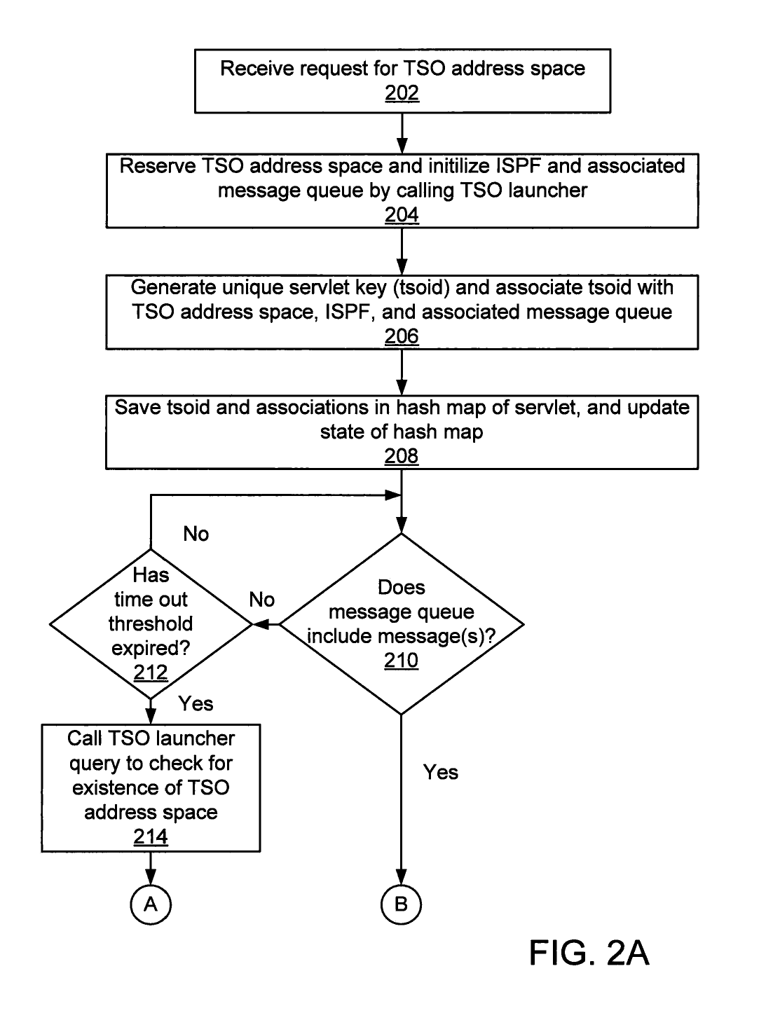

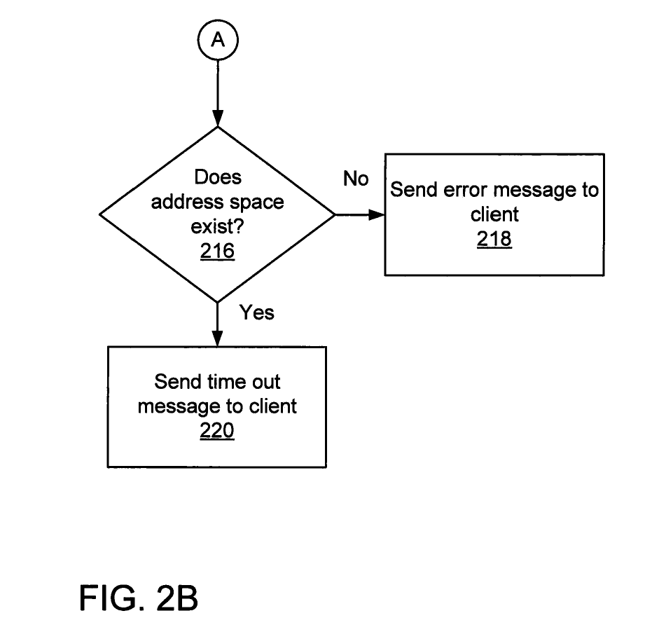

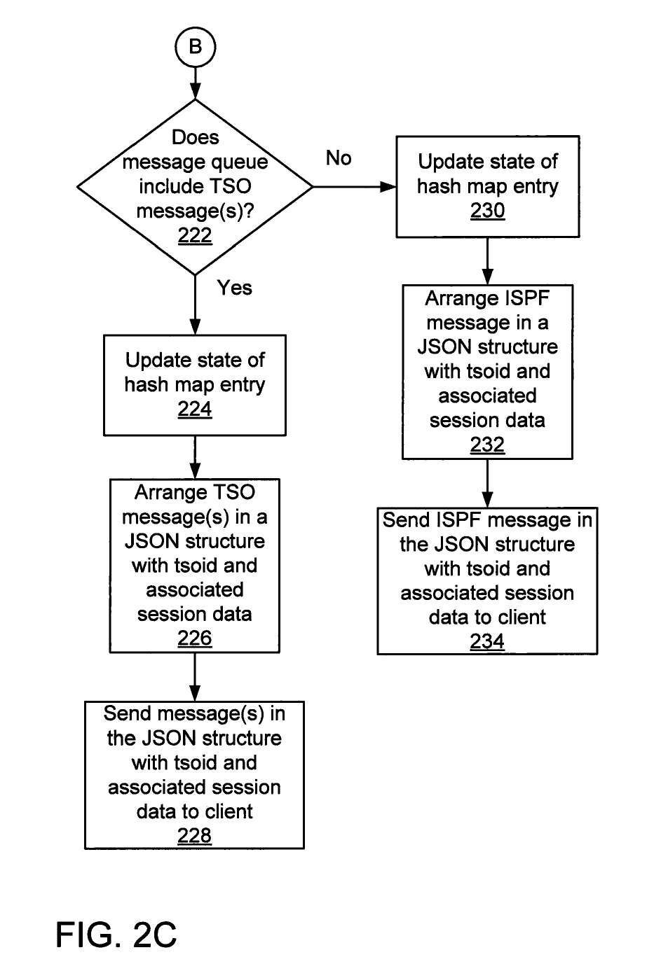

FIGS. 2A-2C illustrate a block diagram of an exemplary method for initializing or reserving a TSO 110 address space (of FIG. 1). Referring to FIG. 2A, in block 202, the servlet 104 receives a request for TSO 110 address space from the user via the client 102. The servlet 104 calls the TSO launcher 106 API, which reserves an address space. In the illustrated embodiment, the TSO launcher 106 API reserves the TSO A 110a address space. When the TSO A 110a address space is reserved, the ISPF A 112a is initialized and the message queue A 108a is initialized and associated with the TSO A 110a address space and the ISPF A 112a in block 204. In block 206, a unique servlet key (tsoid) is generated and associated with the TSO A 110a address space, the ISPF A 112a, and the message queue A 108a. The servlet saves the tsoid and indicators of the associated TSO A 110a address space, the ISPF A 112a, and the message queue A 108a in a hash map, and updates the state of the hash map in block 208. The hash map is maintained by the servlet and may be stored in memory associated with the servlet. In block 210, the servlet 104 reads the message queue A 108a to determine whether the message queue A 108a includes any TSO messages or ISPF messages that may have been sent from the TSO A 110a and/or the ISPF A 112a. In this regard, the TSO A 110a or the ISPF A 112a may send messages addressed to the client 102. The message queue A 108a receives and stores the messages sent from the TSO A 110a or the ISPF A 112a. The servlet 104 uses logic to distinguish any TSO messages from ISPF messages in the message queue A 108a. If TSO messages are present, in the message queue A 108a, the servlet 104 will prioritize the TSO messages for processing. Once the TSO messages are processed, the servlet 104 will process any remaining ISPF messages stored in the message queue A 108a. In block 210, the servlet 104 determines whether the message queue A 108a includes any messages. If no, the servlet 104 determines whether a time out threshold has expired in block 212. If yes, the servlet 104 calls the TSO launcher 106 to query the address space of the TSO A 110a to determine whether the address space exists.

Referring to FIG. 2B, block 216 determines whether the address space (e.g., TSO A 110a) exists in the memory space of the processor 101. If no, the servlet 104 will receive an indication that the address space does not exist from the TSO launcher 106, and send an error message to the client 102 in block 218. If yes, the servlet 104 will receive an indication from the TSO launcher 106 that the address space does exist, and send a time out message to the client 102 in block 220. A time out message may be used to inform the user of the client 102 that the address space is present, and may be, for example, performing a processing task that has a run time greater than the time out threshold. If the message queue does include messages (block 210), in block 222 (of FIG. 2C) the servlet 104 prioritizes the messages in the message queue A 108a by first determining whether the message queue A 108a includes TSO message(s). If yes, the servlet 104 updates the state of the hash map entry in block 224 (e.g., updating the time stamp of the hash map entry). In block 226, the servlet 104 arranges the TSO message(s) in a JavaScript Object Notation (JSON) structure with the tsoid and associated session data. In block 228, the servlet 104 sends the TSO message(s) in the JSON structure with the tsoid and associated session data to the client 102. If the message queue does not include TSO message(s) (in block 222) the remaining ISPF message is processed in block 230 by updating the state of the hash map entry; arranging the ISPF message into a JSON structure with tsoid and associated session data in block 232; and sending the ISPF message in the JSON structure with the tsoid and associate session data to the client 102 in block 234. Therefore, the client 102 receives a JSON structure that includes a header with the tsoid and a version number of the JSON structure. The JSON structure includes either an array of one or more TSO messages and/or prompts for input or else an ISPF panel that has been represented in JSON format. The individual JSON messages include a header followed by name and value pairs to represent the session data. For example a TSO message may include a header identifying the TSO message as either a message or a prompt, a version number, and either a data value that represents the text of a message or the type of prompt.

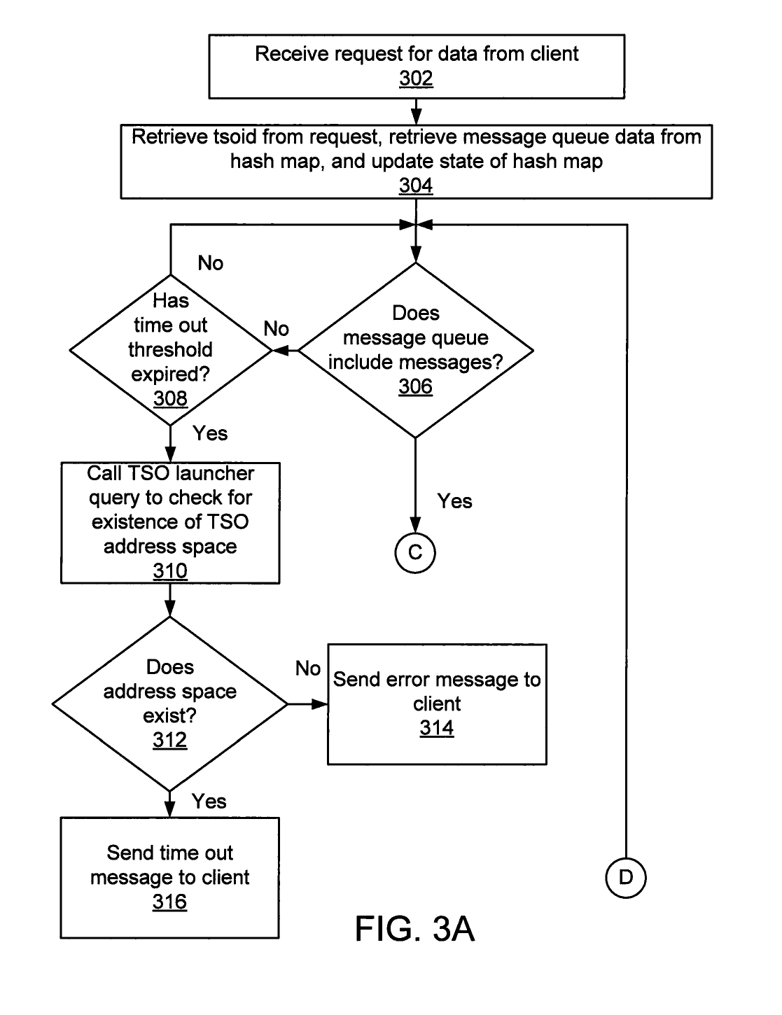

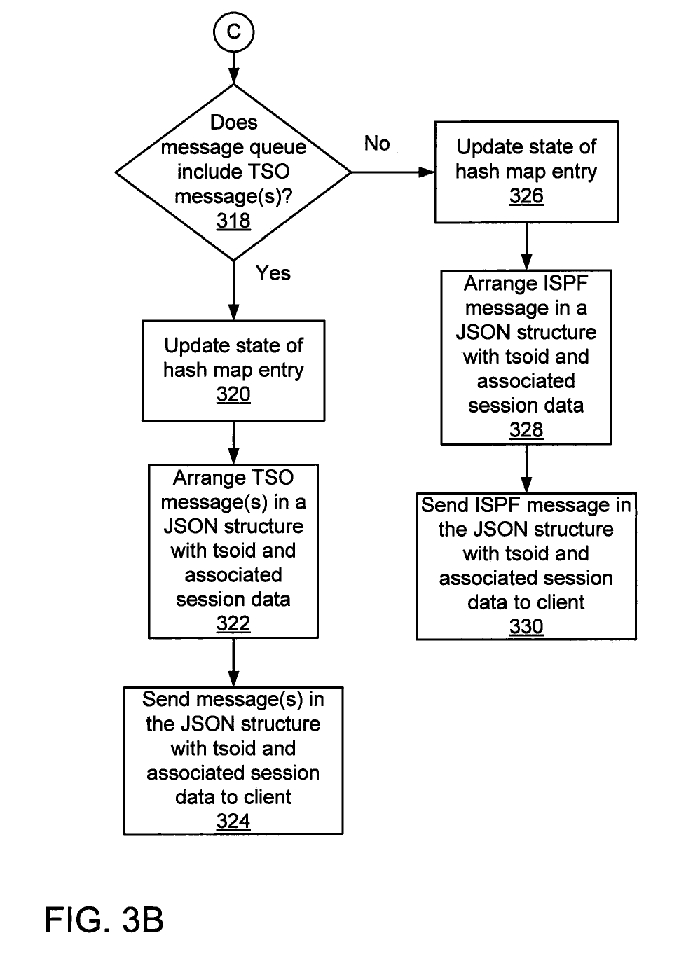

FIGS. 3A-3B illustrate a block diagram of an exemplary method for retrieving data from the TSO 110 address space and ISPF 112 session (of FIG. 1). Referring to FIG. 3A, in block 302, the servlet 104 receives a request for data from the client 102. The request may include either an ISPF or TSO response from the user via the client 102. For example, if the user enters an input with an input device, the input information is sent to the servlet 104 as a response and the servlet 104 will in response return data to the client 102. The request includes the tsoid that was generated in, for example, the method for initializing address space described above. The servlet 104 retrieves the tsoid from the request, retrieves message queue data from the hash map, and updates the state of the hash map in block 304. In block 306, the servlet 104 reads the message queue A 108a to determine whether the message queue A 108a includes any messages that may have been sent from the TSO A 110a and/or the ISPF A 112a as may be indicated by the tsoid received in the request for data from the client 102. In this regard, the TSO A 110a or the ISPF A 112a may send messages addressed to the client 102. The message queue A 108a receives and stores the messages sent from the TSO A 110a or the ISPF A 112a. The servlet 104 uses logic to distinguish any TSO messages from ISPF messages in the message queue A 108a. If TSO messages are present, in the message queue A 108a, the servlet 104 will prioritize the TSO messages for processing. Once the TSO messages are processed, the servlet 104 will process any remaining ISPF messages stored in the message queue A 108a. In block 306, the servlet 104 determines whether the message queue A 108a includes any messages. If no, the servlet 104 determines whether a time out threshold has expired in block 308. If yes, the servlet 104 calls the TSO launcher 106 to query the address space of the TSO A 110a to determine whether the address space exists. In block 310, the servlet 104 calls the TSO launcher to determine whether the address space (e.g., TSO A 110a) exists in the memory space of the processor 101. If no, the servlet 104 will receive an indication that the address space does not exist from the TSO launcher 106, and send an error message to the client 102 in block 314. If yes, the servlet 104 will receive an indication from the TSO launcher 106 that the address space does exist, and send a time out message to the client 102 in block 316. A time out message may be used to inform the user of the client 102 that the address space is present, and may be, for example, performing a processing task that has a run time greater than the time out threshold. If the message queue does include messages (block 306), in block 318 (of FIG. 3B) the servlet 104 prioritizes the messages in the message queue A 108a by first determining whether the message queue A 108a includes TSO message(s). If yes, the servlet 104 updates the state of the hash map entry in block 320. In block 322, the servlet 104 arranges the TSO message(s) in a JavaScript Object Notation (JSON) structure with the tsoid and associated session data in manner similar to the manner described above. In block 324, the servlet 104 sends the TSO message(s) in the JSON structure with the tsoid and associated session data to the client 102. If the message queue does not include TSO message(s) (in block 318) the remaining ISPF message is processed in block 326 by updating the state of the hash map entry; arranging the ISPF message into a JSON structure with tsoid and associated session data in block 328; and sending the ISPF message in the JSON structure with the tsoid and associate session data to the client 102 in block 330.

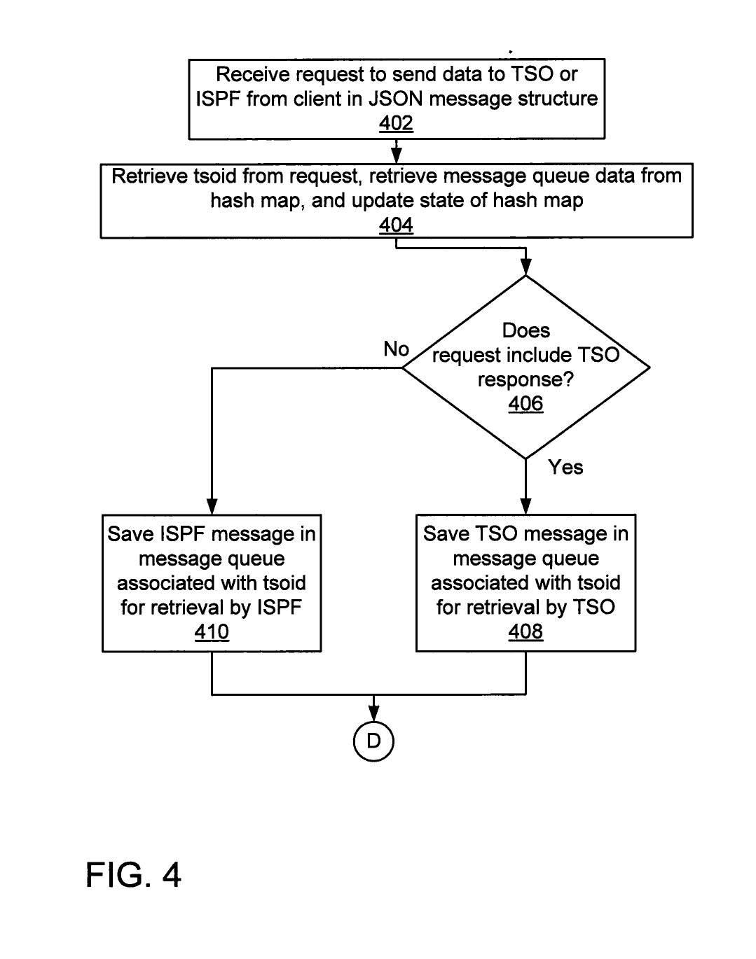

FIG. 4 illustrates a block diagram of an exemplary method for sending data to the TSO 110 address space and ISPF 112 session (of FIG. 1). In block 402, the servlet 104 receives a HTTP request to send data to either the TSO 110 or ISPF 112. The request includes data that is formatted into a JSON structure. The request also may include a tsoid that identifies by association in the hash map of the servlet 104, the message queue 108, TSO 110, and ISPF 112 that should receive the data. In block 404, the tsoid is retrieved from the received request, and message queue data associated with the tsoid is retrieved from the hash map. The state of the hash map is updated. In block 406, the servlet 104 determines whether the request includes a TSO message. If yes, in block 408, the TSO message is saved in the message queue associated with the tsoid for retrieval by the TSO 110. For example, if the tsoid in the received request is associated with the message queue A 108a, the servlet 104 stores the TSO message in the message queue A 108a for retrieval by the TSO A 110a. After block 410, the servlet 104 may determine whether the message queue 108 includes messages in block 306 (of FIG. 3) and follows the block diagram of FIGS. 3A and 3B described above. If the request does not include a TSO message (in block 406), in block 410, the ISPF message is saved in the message queue associated with the tsoid for retrieval by the ISPF 112 in a similar manner as discussed above regarding the TSO message. After block 414, the servlet 104 may determine whether the message queue 108 includes messages in block 306 (of FIG. 3) and follows the block diagram of FIGS. 3A and 3B described above.

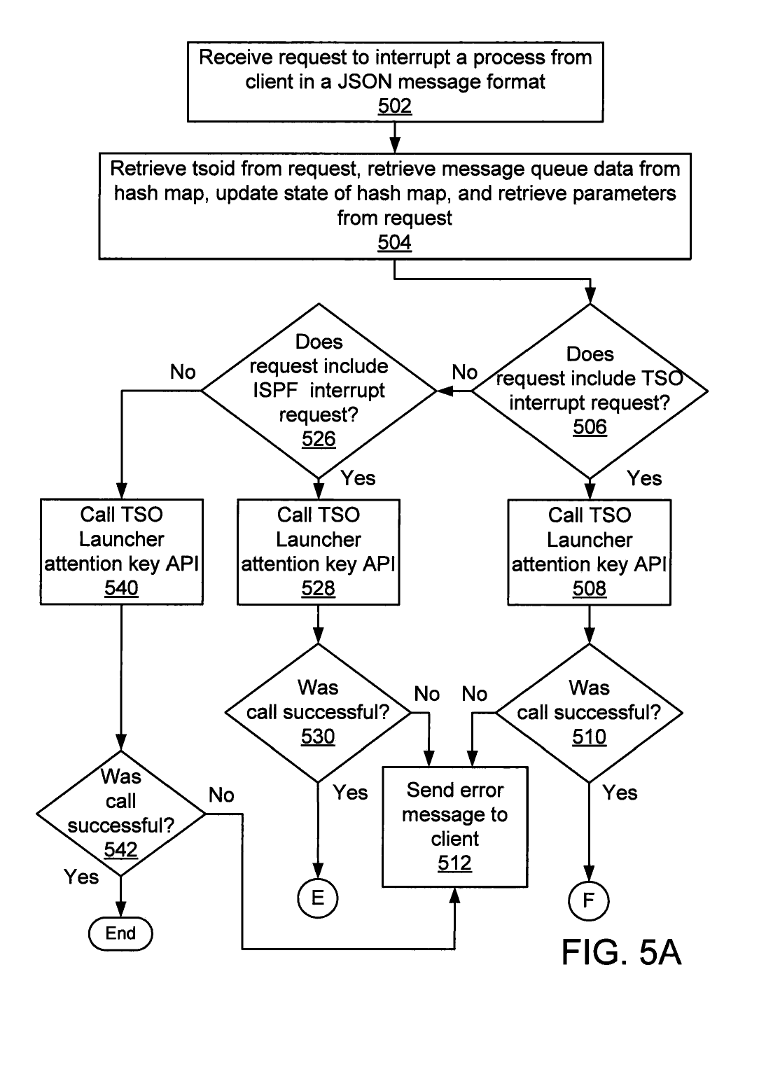

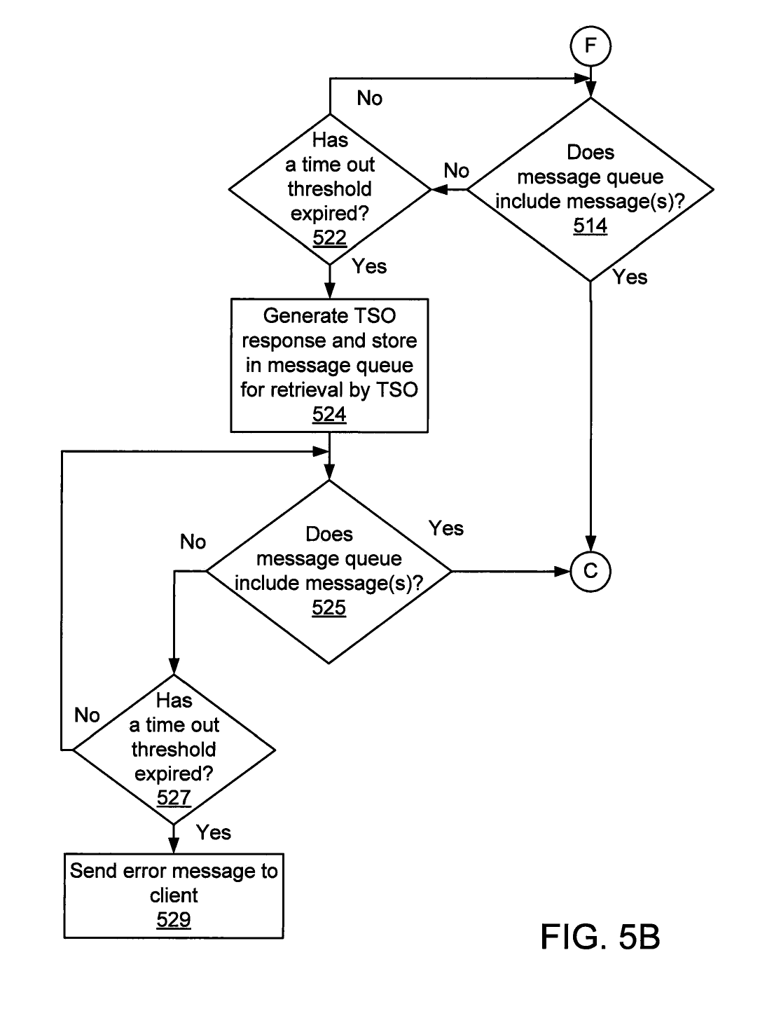

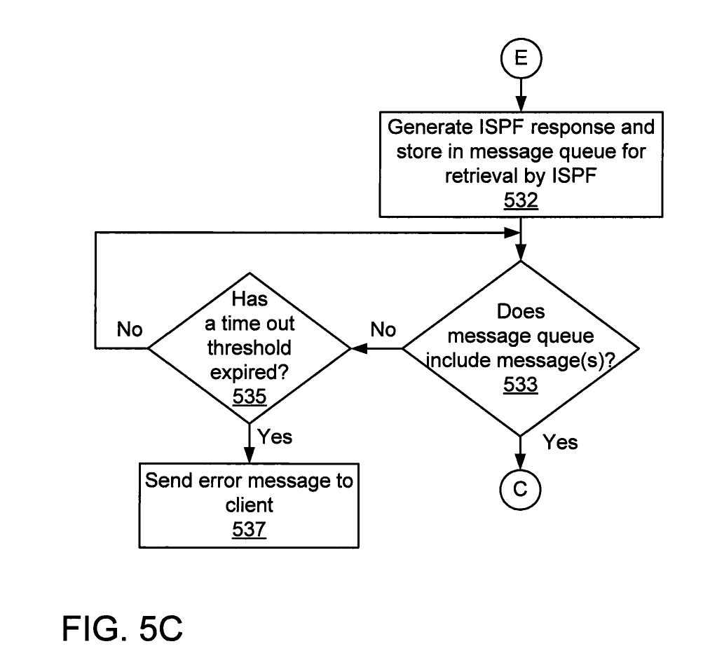

In some instances a user of the client 102 may desire to interrupt a TSO 110 or ISPF 112 process while either of the processes are in progress. In this regard, FIGS. 5A-5C illustrate a block diagram of an exemplary method for interrupting processes. Referring to FIG. 5A, in block 502 the servlet 104 (of FIG. 1) receives a request in JSON format from the client 102 to interrupt either an ISPF or a TSO process. The servlet 104 retrieves the tsoid, message queue data from the hash map, updates the state of the hash map, and retrieves parameters from the interrupt request in block 504. In block 506, the servlet 104 determines whether the request includes a TSO interrupt request, based on the type of attention key request that was specified by the client. If yes, the servlet 104 calls the TSO launcher 106 attention key API to asynchronously interrupt or stop the TSO 110 address space and whatever processing is occurring within the TSO 110 address space. If the TSO launcher indicates the call is unsuccessful by returning an error code, the servlet 104 sends an error message to the client 102 in JSON format, in block 512. If the call is successful, in block 514 (of FIG. 5B), the servlet 104 determines whether there is a new message in the message queue 108. If yes, the servlet 104 may determine whether the message queue 108 includes messages in block 318 (of FIG. 3B) and follows the block diagram of FIG. 3B described above. If the message queue 108 does not include a TSO message (in block 514), the servlet 104 determines whether a time out threshold has expired in block 522. If the time out threshold has expired, the servlet 104 generates a special TSO response message that indicates to TSO that further action is needed for attention processing and stores the message in the message queue 108 for retrieval by the TSO 110 in block 524. In block 525, the servlet 104 determines whether the message queue 108 includes messages. If yes, the servlet 104 then determines whether the message queue 108 includes messages in block 318 (of FIG. 3B) and follows the block diagram of FIG. 3B described above. If no (in block 525), the servlet 104 determines whether a time out threshold has expired in block 527, and sends an error message to the client 102 in block 529 if the time out threshold has expired.

Referring back to FIG. 5A, if the request does not include a TSO interrupt request (in block 506), the servlet 104 determines whether the request includes an ISPF interrupt request in block 526, based on the type of attention key request that was specified by the client 102. If yes, the servlet 104 calls the TSO launcher 106 attention key API in block 528, and determines whether the call was successful in block 530. If the TSO launcher indicates the call was unsuccessful by returning an error code, the servlet 104 sends an error message to the client 102 in block 512. If the call was successful (in block 530), in block 532 (of FIG. 5C), the servlet 104 generates a ISPF response message, that indicates to ISPF that further action is needed for attention processing and stores the message in the message queue 108. In block 533, the servlet 104 determines whether the message queue includes any messages. If no, the servlet determines whether a time out threshold has expired in block 535 and sends an error message to the client 102 in block 537 if the time out threshold has expired. If the message queue does include messages (in block 533), the servlet 104 determines whether the message queue 108 includes messages in block 318 (of FIG. 3B) and follows the block diagram of FIG. 3B described above.

Referring again back to FIG. 5A, if the request does not include an ISPF interrupt request (in block 526), the servlet calls the TSO launcher 106 attention key API in block 540, and determines whether the call was successful in block 542. If the call was successful, as indicated by the return code from the TSO launcher, the message queue 108 is checked for any TSO or ISPF messages to return to the client. If the call was unsuccessful, an error message is sent from the servlet 104 to the client 102 in block 512.

The servlet 104 may receive a request to terminate a TSO address space from the client 102. In this regard, the servlet 104 receives a request to terminate the address space and retrieves the tsoid from the request. The servlet 104 uses the hash map to identify the address space structure associated with the tsoid and calls the TSO launcher 106 API with a call to end the TSO associated with the request. The servlet 104 may then remove the associated entry from the hash map.

The servlet 104 may receive a ping from the client 102 periodically so that the client 102 may indicate to the servlet 104 that the client 102 is still active. In this regard, servlet 104 receives a request (i.e., a message) that indicates that the client 102 is active. The servlet 104 retrieves the tsoid from the request and updates the timestamp in the hash map associated with the client 102.

The servlet 104 may clean up inactive sessions by periodically checking the hash map to determine whether there are any entries in the hash map with time stamps that are older than a threshold value. The servlet 104 identifies “stale” entries and determines the state of the stale entries. If the state of the session is a starting state, the servlet 104 deletes the entry from the hash map. If an ISPF 112 is active, the servlet 104 generates a termination ISPF message and saves the termination message in the message queue 108. ISPF 112 will retrieve the message from the message queue 108 and perform an ISPF termination process. The servlet 104 issues a call to the TSO launcher 106 API to end the TSO address space and deletes the associate entry from the hash map.

The servlet 104 may periodically send a ping to the TSO launcher 106 to inform the TSO launcher 106 that the servlet 104 is active. In this regard, the servlet 104 sends a call to the TSO launcher 106 that pings the TSO launcher 106 API with an appTag to identify the servlet 104 in order to differentiate the servlet 104 from any other applications that may use the TSO launcher 106.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method comprising:
receiving a request for a time sharing option (TSO) address space from a client application;
reserving a TSO address space in a processor;
initializing a interactive system productivity facility (ISPF) session in the TSO address space;
initializing a message queue associated with the TSO address space and the ISPF session;
generating a unique key associated with the client application, the TSO address space, the ISPF session, and the message queue; and
entering the unique key and an association of the unique key with the client application, the TSO address space, the ISPF session, and the message queue into a hash map entry.

2. The method of claim 1, wherein the method further comprises:
determining whether the message queue includes a message;
determining whether the TSO address space exists responsive to determining that the message queue does not include a message;
sending a message indicative of an error to the client application responsive to determining that the TSO address space does not exist; and
sending a message indicative of a time out to the client application responsive to determining that the TSO address space does exist.

3. The method of claim 1, wherein the method further compromises:
determining whether the message queue includes at least one TSO message;
arranging the at least one TSO message into a Java script object notation (JSON) structure with the unique key associated with the client application and the message queue responsive to determining that the message queue includes at least one TSO message; and
sending the at least one TSO message arranged into the JSON structure with the unique key associated with the client application and the message queue to the client application.

4. The method of claim 1, wherein the method further comprises:
determining whether the message queue includes an ISPF message;
arranging the ISPF message into a Java script object notation (JSON) structure with the unique key associated with the client application and the message queue responsive to determining that the message queue includes an ISPF message; and
sending the at least one ISPF message arranged into the JSON structure with the unique key associated with the client application and the message queue to the client application.

5. The method of claim 1, wherein the method further comprises:
receiving a request for data from the client application that includes the unique key;
associating the request for data with the message queue;
determining whether the message queue includes a message with the unique key;
determining whether the TSO address space associated with the unique key exists responsive to determining that the message queue does not include a message with the unique key;
sending a message indicative of an error to the client application responsive to determining that the TSO address space does not exist; and
sending a message indicative of a time out to the client application responsive to determining that the TSO address space does exist.

6. The method of claim 1, wherein the method further comprises:
receiving a request for data from the client application that includes the unique key;
associating the request for data with the message queue;
determining whether the message queue includes a message with the unique key;
arranging the message into a Java script object notation (JSON) structure with the unique key associated with the client application and the message queue responsive to determining that the message queue includes the message; and
sending the message arranged into the JSON structure with the unique key associated with the client application and the message queue to the client application.

7. The method of claim 1, wherein the method further comprises:
receiving a request to send data from the client application, the request including the unique key;
determining whether the request to send data from the client application includes a TSO message;
formatting the request from the client application into a TSO message format responsive to determining that the request includes a TSO message;
saving the formatted request in the TSO message format in the message queue associated with the unique key.

8. The method of claim 7, wherein the method further comprises:
determining whether the request from the client application includes an ISPF message;
formatting the request from the client application into a ISPF message format responsive to determining that the request includes a ISPF message;
saving the formatted request from the client application in the ISPF message format in the message queue associated with the unique key.

9. A method comprising:
receiving a request to interrupt a process from a client application;
retrieving a unique key from the request;
identifying a time sharing option (TSO) address space of a processor associated with the unique key;
determining whether the request includes a request to interrupt a process in the TSO address space; and
calling the TSO address space with an interrupt instruction responsive to determining that the request includes a request to interrupt the process in the TSO address space.

10. The method of claim 9, wherein the method further comprises:
determining whether the call to the TSO address space with the interrupt instruction was successful; and
determining whether the message queue includes at least one message responsive to determining that the call to the TSO address space with the interrupt instruction was successful;
arranging the at least one message into a Java script object notation (JSON) structure with the unique key associated with the client application and the message queue responsive to determining that the message queue includes at least one TSO message; and
sending the at least one message arranged into the JSON structure with the unique key associated with the client application and the message queue to the client application.

11. The method of claim 9, wherein the method further comprises:
determining whether the request includes a request to interrupt a process in an ISPF associated with the TSO address space; and
calling the ISPF with an interrupt instruction responsive to determining that the request includes a request to interrupt the process in the ISPF.

12. The method of claim 11, wherein the method further comprises:
determining whether the call to the ISPF with the interrupt instruction was successful;
determining whether the message queue includes an ISPF message responsive to determining that the call to the ISPF with the interrupt instruction was successful;
arranging the ISPF message into a Java script object notation (JSON) structure with the unique key associated with the client application and the message queue responsive to determining that the message queue includes the ISPF message; and
sending the ISPF message arranged into the JSON structure with the unique key associated with the client application and the message queue to the client application.

13. A system comprising:
a processor operative to receive a request for a time sharing option (TSO) address space from a client application, reserve a TSO address space, initialize a interactive system productivity facility (ISPF) in the TSO address space, initialize a message queue associated with the TSO address space and the ISPF, generate a unique key associated with the client application, the TSO address space, the ISPF, and the message queue, and enter the unique key and an association of the unique key with the client application, the TSO address space, the ISPF, and the message queue into a hash map entry.

14. The system of claim 13, wherein the processor is further operative to determine whether the message queue includes a message, determine whether the TSO address space exists responsive to determining that the message queue does not include a message, send a message indicative of an error to the client application responsive to determining that the TSO address space does not exist, and send a message indicative of a time out to the client application responsive to determining that the TSO address space does exist.

15. The system of claim 13, wherein the processor is further operative to determine whether the message queue includes at least one TSO message, arrange the at least one TSO message into a Java script object notation (JSON) structure with the unique key associated with the client application and the message queue responsive to determining that the message queue includes at least one TSO message, and send the at least one TSO message arranged into the JSON structure with the unique key associated with the client application and the message queue to the client application.

16. The system of claim 13, wherein the processor is further operative to determine whether the message queue includes an ISPF message, arrange the ISPF message into a Java script object notation (JSON) structure with the unique key associated with the client application and the message queue responsive to determining that the message queue includes an ISPF message, and send the at least one ISPF message arranged into the JSON structure with the unique key associated with the client application and the message queue to the client application.

17. The system of claim 13, wherein the processor is further operative to receive a request for data from the client application that includes the unique key, associate the request for data with the message queue, determine whether the message queue includes a message with the unique key, determine whether the TSO address space associated with the unique key exists responsive to determining that the message queue does not include a message with the unique key, send a message indicative of an error to the client application responsive to determining that the TSO address space does not exist, and send a message indicative of a time out to the client application responsive to determining that the TSO address space does exist.

18. The system of claim 13, wherein the processor is further operative to receive a request for data from the client application that includes the unique key, associate the request for data from the client application with the message queue, determine whether the message queue includes a message with the unique key, arrange the message into a Java script object notation (JSON) structure with the unique key associated with the client application and the message queue responsive to determining that the message queue includes the message, and send the message arranged into the JSON structure with the unique key associated with the client application and the message queue to the client application.

19. The system of claim 13, wherein the processor is further operative to receive a request to send data from the client application, the request to send data from the client application including the unique key, determine whether the request to send data from the client application includes a TSO message, format the request to send data from the client application into a TSO message format responsive to determining that the request to send data from the client application includes a TSO message, save the formatted request in the TSO message format in the message queue associated with the unique key.

20. The system of claim 19, wherein the processor is further operative to determine whether the request to send data from the client application includes an ISPF message, format the request to send data from the client application into a ISPF message format responsive to determining that the request to send data from the client application includes a ISPF message, save the formatted request to send data from the client application in the ISPF message format in the message queue associated with the unique key.

21. A system comprising:
a processor operative to receive a request to interrupt a process from a client application, retrieve a unique key from the request, identify a time sharing option (TSO) address space associated with the unique key, determine whether the request includes a request to interrupt a process in the TSO address space, and call the TSO address space with an interrupt instruction responsive to determining that the request includes a request to interrupt the process in the TSO address space.

22. The system of claim 21, wherein processor is further operative to determine whether the call to the TSO address space with the interrupt instruction was successful; and determine whether the message queue includes at least one TSO message responsive to determining that the call to the TSO address space with the interrupt instruction was successful, arranging the at least one TSO message into a Java script object notation (JSON) structure with the unique key associated with the client application and the message queue responsive to determining that the message queue includes at least one TSO message, and sending the at least one TSO message arranged into the JSON structure with the unique key associated with the client application and the message queue to the client application.

23. The system of claim 21, wherein processor is further operative to determine whether the request includes a request to interrupt a process in an interactive system productivity facility (ISPF) associated with the TSO address space, and call the ISPF with an interrupt instruction responsive to determining that the request includes a request to interrupt the process in the ISPF.

24. The system of claim 23, wherein processor is further operative to determine whether the call to the ISPF with the interrupt instruction was successful, determine whether the message queue includes an ISPF message responsive to determining that the call to the ISPF with the interrupt instruction was successful, arrange the ISPF message into a Java script object notation (JSON) structure with the unique key associated with the client application and the message queue responsive to determining that the message queue includes the ISPF message, and send the ISPF message arranged into the JSON structure with the unique key associated with the client application and the message queue to the client application.
